(19) United States
(12) Patent Application Publication
(10) Pub. No.: US 2005/0052111 A1
(43) Pub. Date: Mar. 10, 2005

(54) Convergence compensating deflection yoke

(75) Inventors: Jae B. Han, Suwon-Shi (KR); Jong W. Park, Suwon-Shi (KR); Jae K. Song, Suwon-Shi (KR)

Correspondence Address: DARBY & DARBY P.C., P. O. BOX 5257, NEW YORK, NY, 10150-5257, US

(73) Assignee: Samsung Electro-Mechanics Co., Ltd., Suwon-Shi (KR)

(21) Appl. No.: 10/891,432

(22) Filed: Jul. 13, 2004

Related U.S. Application Data
(63) Continuation of application No. 09/803,511, filed on Mar. 9, 2001, now abandoned.

(30) Foreign Application Priority Data
Sep. 30, 2000 (KR) 2000-57601

(51) Int. Cl. H01J 29/70; H01J 29/46

(52) U.S. Cl. 313/440; 313/441

(57) ABSTRACT

The present invention relates to a deflection yoke which includes an iron plate on a neck portion of a coil separator to convert PQH from a negative tendency to a positive one so that degradation of convergence features can be prevented. The deflection yoke of the invention comprises: a coil separator including a screen portion coupled to a screen panel of a CRT, a rear cover, and a neck portion extended from the central plane of the rear cover to be coupled to an electron gun portion of the CRT; horizontal and vertical deflection coils provided in the inner and outer sides of the coil separator to form horizontal and vertical deflection magnetic fields to control an electron beam; and compensating means provided in the neck portion of the coil separator to compensate convergence on a screen. The negative tendency of PQH according to the flattening of the CRT can be changed into the positive tendency by providing the compensating iron plates in the rear plate side of the coil separator in the shape of wrapping the neck portion.

### BACKGROUND OF THE INVENTION

1. Field of the Invention

The present invention relates to a deflection yoke, and more particularly to a deflection yoke which can improve the deterioration of convergence properties as a CRT (Cathode Ray Tube) is flattened.

2. Description of the Prior Art

In general, the CRT of a TV or monitor has the deflection yoke for deflecting three-color beam scanned from an electron gun correctly to a fluorescent screen applied on a screen panel of the CRT. The deflection functions to deflect electron beam shot from the electron gun yoke as the most important element of magnetic devices of the CRT, so that electric signals transmitted in time sequence can be regenerated on a screen of the CRT.

In other words, since the electron beam from the electron gun simply causes phosphors only in the center of the screen to radiate as proceeding straight onto the screen, the deflection yoke externally deflects the electron beam onto the screen in the order of scanning. The defection yoke forms a magnetic field so that the electron beam is forced during passing a magnetic field and changes the proceeding direction thereof. Therefore, the electron beam is introduced correctly to the fluorescent screen coated on the screen panel of the CRT.

FIG. 1 is a side elevational view of a general CRT. As shown in FIG. 1, a deflection yoke 4 is arranged in an RGB electron gun unit 3 of a CRT 1 to deflect electron beam scanned from an electron gun 3a to a fluorescent screen coated on the screen panel.

The deflection yoke 4 like this includes a coil separator 10 which is mainly constructed of a pair of up and down sections to be coupled together into one part.

The coil separator 10 are provided to insulate a horizontal deflection coil 15 and a vertical deflection coil 16 and assembly them in place. The coil separator 10 include a screen portion 11a coupled to a screen panel side, a rear cover 11b, and a neck portion 12 integrally extended from the central plane of the rear cover 11b to be coupled with an electron gun portion 3 of the CRT 1.

Horizontal and vertical deflection coils 15 and 16 are arranged in the inner and outer peripheries of the coil separator 10 like this to generate a horizontal deflection magnetic field and a vertical deflection magnetic field from an externally applied power.

A pair of ferrite cores 14 are provided to surround the vertical deflection coils 16 and formed with a magnetic substance to strengthen the vertical deflection magnetic field generated from the vertical deflection coils 16.

The deflection yoke 4 configured like this is installed in the neck portion 12 of the CRT to deflect an RGB electron beam for scanning location on the screen, in which the RGB electron beams are radiated from the electron gun 3a of the CRT 1 from the generation of the magnetic field due to Fleming's left-hand rule when a sawtooth pulse is applied to the horizontal deflection coils 15 and the vertical deflection coils 16.

Meanwhile, the deflection yokes as shown in FIG. 1 are mainly classified into a saddle-saddle type deflection yoke as shown in FIG. 2 and FIG. 3 and a saddle-toroidal deflection yoke as shown in FIG. 4 and FIG. 5 according to the winding structure of the coil.

Here, the saddle-saddle type deflection yoke shown in FIG. 2 and FIG. 3 has horizontal deflection coils 15 installed in upper and lower sides of the inner periphery of a screen portion of the substantially conical coil separator 10 and vertical deflection coils 16 installed in right and left sides of the outer periphery.

In order to strengthen a magnetic field of the vertical deflection coils 16, the screen portion 11a of the coil separator 10 has a substantially circular ferrite cores 14 in the outer periphery of the screen portion 11a.

Also, a coma free coil (not shown) is installed around the outer periphery of a neck portion 12 of the coil separator 10 to compensate a coma generated from the vertical deflection coils 16.

Typical saddle-toroidal deflection yokes are shown in FIG. 4 and FIG. 5.

The deflection yokes have horizontal deflection coils 15 installed in upper and lower sides of the inner periphery of a screen portion 11a of the substantially conical coil separator 10, substantially circular ferrite cores 14 in the outer periphery and toroidal vertical deflection coils 16 along upper and lower sides of the ferrite cores 14.

Also, a coma free coil (not shown) is additionally installed around the outer periphery of a neck portion 12 of the coil separator 10 to compensate a coma generated from the vertical deflection coils 16.

In addition, the saddle-saddle and saddle-toroidal deflection yokes have a printed circuit board in one side of the coil separator to supply power to the foregoing horizontal deflection coils 15 and vertical deflection coils 15.

However, the foregoing deflection yokes of the conventional art have a problem that a deterioration of distortion on the screen is resulted as the CRT is flattened.

In other words, miss-convergence and G/D (Geometric Distortion) on the screen are incurred as the CRT is flattened.

Such miss-convergence is mainly classified into YV miss-convergence and YHC miss-convergence. YV miss-convergence means vertical miss-convergence where a horizontal line of red color R is biased from a horizontal line of blue color B in the upper and lower portions of the screen in the Y axis as shown in FIG. 6 and FIG. 7. YHC miss-convergence means vertical miss-convergence in which vertical lines R and B are crossed with each other as shown in FIG. 8.

Herein, G/D means the state in which the screen is distorted different from normal state as shown in FIG. 9 and FIG. 10.

In particular, N/S distortion takes place and a pin becomes positive as the CRT is flattened, in which PQH becomes negative as shown in FIG. 12 while the upper and lower portions of the magnetic wave in the Y axis are deflected outwardly as shown in an analytical drawing of a horizontal magnetic field of FIG. 11, and as a result, B and R in the diagonal directions are diverged about the Y axis.

FIG. 13 illustrates that N/S distortion becomes positive according to magnetic field features of FIG. 11.

FIG. 14 to FIG. 16 show miss-convergence and distortion according to a vertical magnetic field analysis.

As N/S distortion takes place and the pin becomes negative, such miss-convergence on the screen creates a problem that is the very immediate cause of degrading qualities of products.

### SUMMARY OF THE INVENTION

It is therefore an object of the present invention to provide a deflection yoke which includes an iron plate on a neck portion of a coil separator to convert PQH from a negative tendency to a positive one so that degradation of convergence features can be prevented to enhance qualities of products.

To obtain the foregoing object according to the present invention, it is provided a deflection yoke comprising: a coil separator including a screen portion coupled to a screen panel of a CRT, a rear cover, and a neck portion extended from the central plane of the rear cover to be coupled to an electron gun portion of the CRT; horizontal and vertical deflection coils provided in the inner and outer sides of the coil separator to form horizontal and vertical deflection magnetic fields to control an electron beam; and compensating means provided in the neck portion of the coil separator to compensate convergence on a screen.

The compensating means according to the invention are constructed of a pair of iron plates which are attached to one side of said rear cover while wrapping the outer periphery of said neck portion in opposite directions with each other.

The pair of iron plates according to the invention are made of a magnetic substance, in which each of said iron plates has a semi-circular configuration about said neck portion.

The pair of iron plates are fixed in place by using an adherence.

### BRIEF DESCRIPTION OF THE DRAWING

FIG. 1 is a side elevational view for showing a general CRT;

FIG. 2 is a front sectional view for showing a conventional saddle-saddle type deflection yoke;

FIG. 3 is a plan view of FIG. 2;

FIG. 4 is a front sectional view for showing a conventional saddle-toroidal deflection yoke;

FIG. 5 is a plan view of FIG. 4;

FIG. 6 to FIG. 16 show miss-convergence patterns on a screen in a conventional deflection yoke;

FIG. 17 is a plan view for showing a deflection yoke according to the invention; and

FIG. 18 to FIG. 23 show convergence patterns on a screen in a deflection yoke adopting a compensating means according to the invention.

### DESCRIPTION OF THE PREFERRED EMBODIMENTS

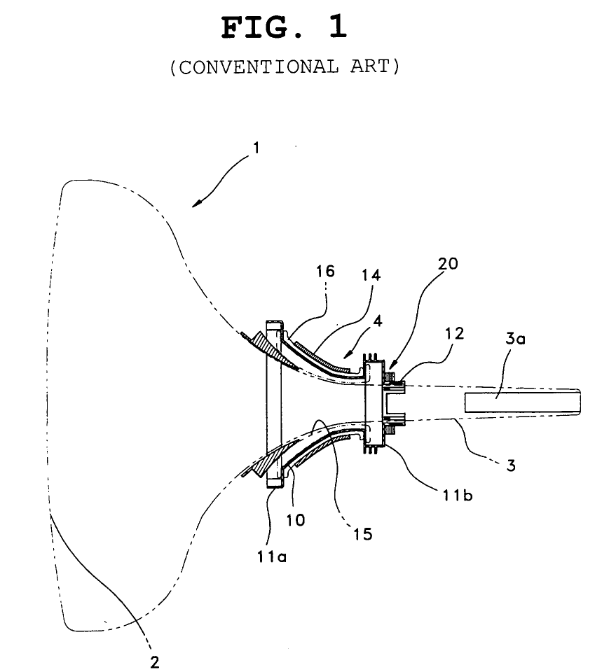

Hereinafter preferred embodiments of a deflection yoke of the present invention will be described in detail in reference to appended drawings. Like elements are referred to by like numbers in referring FIG. 1 to FIG. 5.

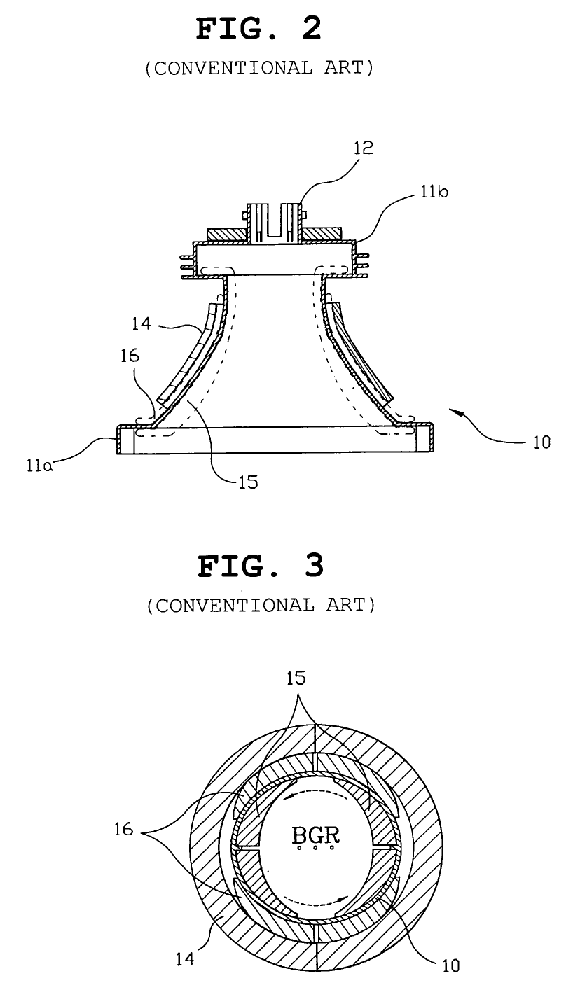

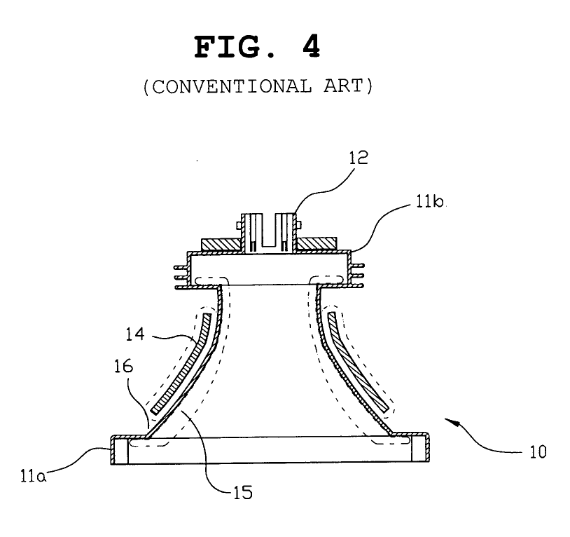

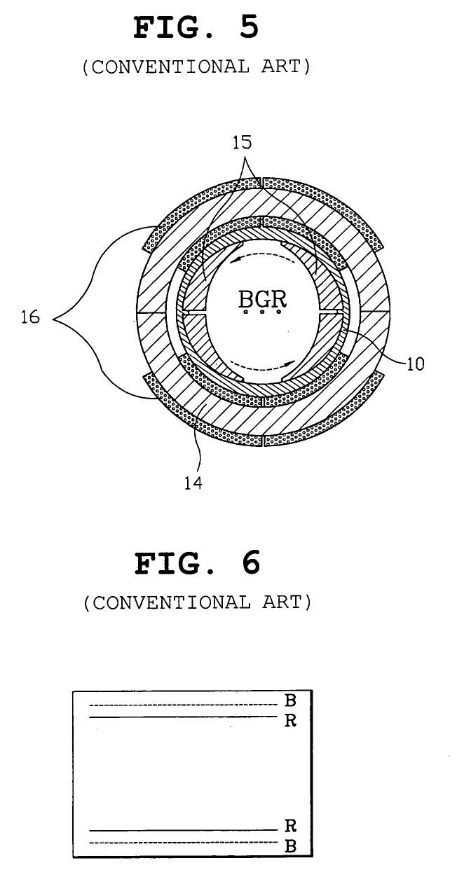

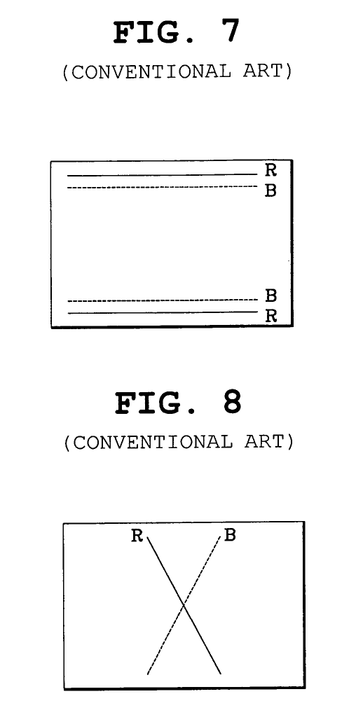

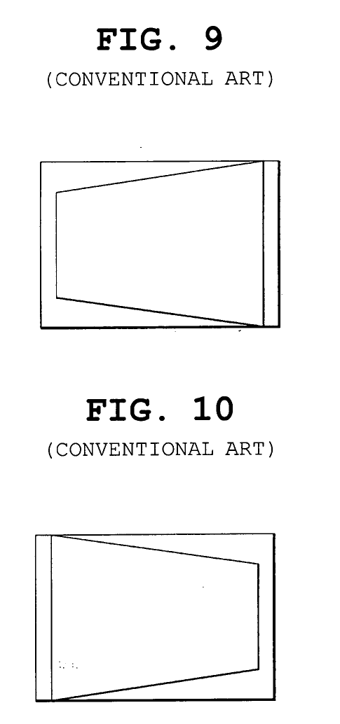

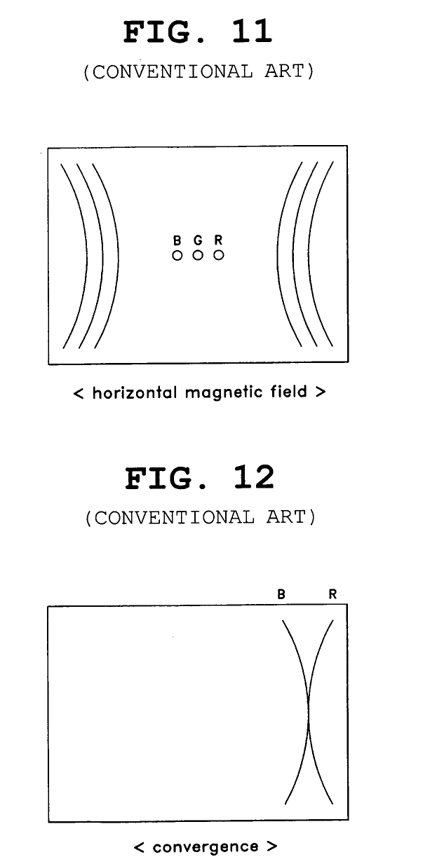

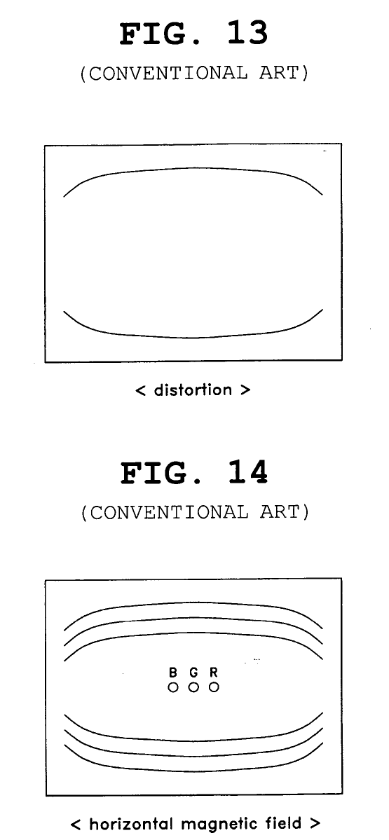

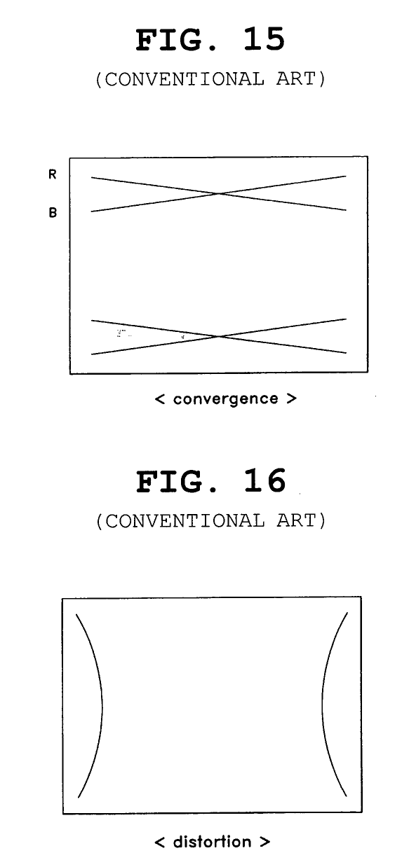

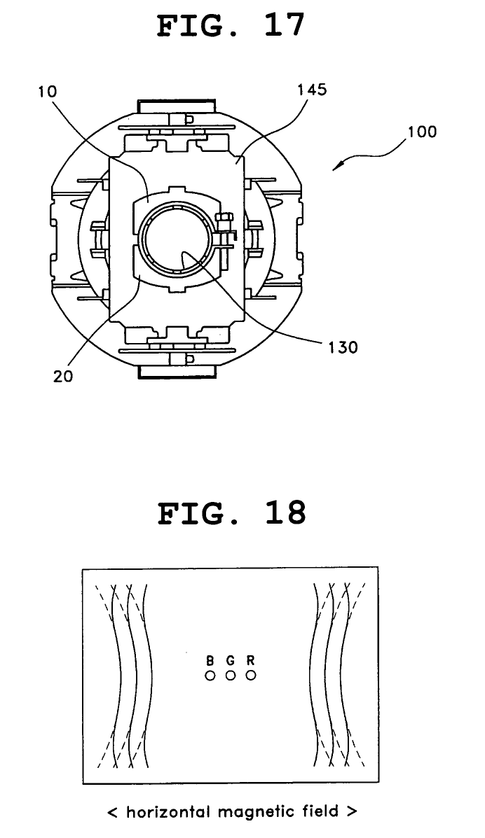

Referring to FIG. 1 to FIG. 5, the general deflection yoke shown in FIG. 1 is placed in the RGB electron gun portion 3 of the CRT 1 to deflect the electron beam scanned from the electron gun 3a onto the fluorescent screen coated on the screen panel 2, and is mainly classified into the saddle-saddle type deflection yoke as shown in FIG. 2 and FIG. 3 and the saddle-toroidal deflection yoke as shown in FIG. 4 and FIG. 5.

Such a deflection yoke 4 functions to deflect the electron beam shot from the RGB electron gun 3a installed in the neck portion 12 of the CRT in right, left, upward and downward directions so that the electron beam can collide in position against the fluorescent screen of the CRT.

FIG. 2 and FIG. 3 show a general type of the saddle-saddle type deflection yoke, in which the saddle type horizontal deflection coils 15 are installed in the upper and lower portions of the inner periphery of the screen portion 11a of the substantially circular coil separator 10, and the saddle type vertical deflection coils 16 are installed in the right and left portions of the outer periphery thereof.

Also, the substantially circular ferrite cores 14 are installed in the outer periphery of the screen portion 11a of the coil separator in order to reinforce the magnetic field of the vertical deflection coils 16.

Also, the coma-free coils (not shown) are additionally installed around the outer periphery of the neck portion 12 of the coil separator to compensate the coma generated from the vertical deflection coils 16.

FIG. 4 and FIG. 5 show a general type of the saddle-toroidal deflection yoke, in which the horizontal deflection coils 15 are installed in the upper and lower portions of the inner periphery of the screen portion 11a of the substantially circular coil separator 10, and the substantially circular ferrite cores 14 are installed in the outer periphery. Also, the toroidal vertical deflection coils 16 are wound along the upper and lower portions of the ferrite cores 14.

Also, the coma-free coils (not shown) are additionally installed around the outer periphery of the neck portion 12 of the coil separator to compensate the coma generated from the vertical deflection coils 16.

Besides, the saddle-saddle type and saddle-toroidal deflection yokes include the printed circuit board installed in one side of the coil separator 10 to supply power to the foregoing horizontal deflection coils 15 and the vertical deflection coils 16.

Meanwhile, the deflection yokes configured as above have a problem that miss-convergence takes place on the screen since PQH qualities become negative as the CRT is flattened.

The present invention is proposed to solve this problem by providing a compensating means in one side of a rear plate 145 adjacent to a neck portion of a coil separator 100.

In other words, the compensating means for compensating miss-convergence due to magnetic features of the deflection yoke is comprised of a pair of iron plates 10 and 20 in one side of the rear plate 145 adjacent to the neck portion 130 of the coil separator 100. The iron plates 10 and 20 are arranged to oppose each other about the neck portion 130.

The compensating means or the iron plates 10 and 20 are provided to oppose each other as turned to each other with the angle of 180° at same distance, and coupled together to partially cover the outer periphery of the neck portion 130.

In other words, the pair of iron plates 10 and 20 are coupled together to partially wrap the outer surface of the neck portion 130.

Meanwhile, the pair of iron plates 10 and 20 are constructed to have a semi-circular configuration about the neck portion 130 and formed of a plate with a certain thickness.

In general, the foregoing pair of iron plates 10 and 20 can be formed of a magnetic substance, and can be fixed to one side of the rear plate 145 by using an adherence, etc.

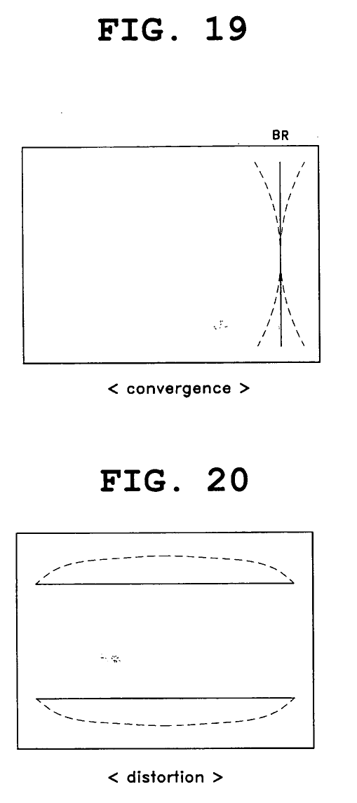

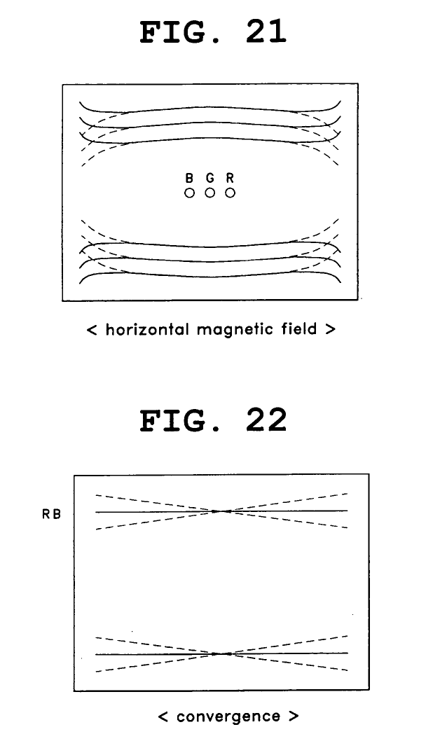

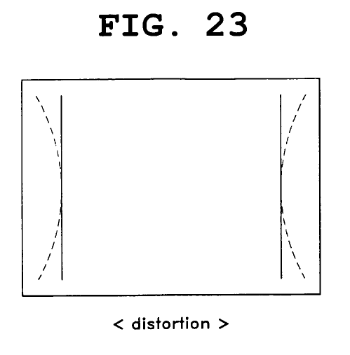

In order to solve the problem that distortion degradation is caused from N/S distortion and a negative tendency of a pin magnetic field as the CRT is flattened, the deflection yoke of the invention configured like this firstly compensates convergence by adjusting the convergence features via magnet attachment and position displacement of the ferrite cores 105 or magnetic field variation, in which the iron plates 10 and 20 are provided in the rear plate 145 in opposed positions in the shape of wrapping the neck portion 130 to change PQH features into a positive tendency from the negative tendency generated during this process as shown with solid lines in FIG. 18 to FIG. 23.

Numerical values of convergence features of the deflection yoke where the pair of iron plates 10 and 20 are provided as opposed in one side of the rear plate 145 adjacent to the neck portion 130 are compared with those where the iron plates 10 and 20 are not provided as in Table 1:

TABLE 1

| | | Conventional |
|---|---|---|
| | Embodiment | Example |
| PQH | 0.2000 | −0.1500 |
| PQV | −0.2000 | −0.0700 |
| VCR | −0.0400 | 1.0800 |
| TRM | −0.1100 | 0.3400 |
| N/S | −0.25 mm | −2.00 mm |
| E/W | −0.50 mm | −1.25 mm |

As described hereinbefore, it can be seen that the convergence features of the deflection yoke having the pair of iron plates 10 and 20 in the neck portion 130 are improved compared to the conventional deflection yoke.

As a result, the compensation is carried out harmoniously so that screen degradation can be prevented.

In other words, according to the deflection yoke of the invention as described hereinbefore, the negative tendency of PQH according to the flattening of the CRT can be changed into the positive tendency by providing the compensating iron plates in the rear plate side of the coil separator in the shape of wrapping the neck portion.

Therefore, there is an advantage that convergence degradation can be prevented to harmoniously carry out the screen compensation thereby enhancing reliability of the CRT adopting the deflection yoke of the invention.

1. A deflection yoke comprising:
a coil separator including a screen portion coupled to a screen panel of a CRT, a rear cover, and a neck portion extended from the central plane of said rear cover for being coupled to an electron gun portion of the CRT;
horizontal and vertical deflection coils provided in the inner and outer sides of said coil separator for forming horizontal and vertical deflection magnetic fields to control an electron beam; and
compensating means provided in said neck portion of said coil separator for compensating convergence on a screen.

2. A deflection yoke according to claim 1, wherein said compensating means constructed of a pair of iron plates which are attached to one side of said rear cover while wrapping the outer periphery of said neck portion in opposite directions with each other.

3. A deflection yoke according to claim 2, wherein said pair of iron plates are made of a magnetic substance, and wherein each of said iron plates has a semi-circular configuration about said neck portion.

4. A deflection yoke according to claim 2, wherein said pair of iron plates are fixed in place by using an adherence.
